(19) United States
(12) Patent Application Publication
(10) Pub. No.: US 2026/0095789 A1
(43) Pub. Date: Apr. 2, 2026

(54) CHANNEL STATE INFORMATION ACQUISITION OF CANDIDATE CELLS

(71) Applicant: InterDigital Patent Holdings, Inc., Wilmington, DE (US)

(72) Inventors: Paul Marinier, Brossard (CA); Brian Martin, Farnham (GB); Oumer Teyeb, Montreal (CA); Chia-Hung Wei, Chesterbrook, PA (US); Martino M. Freda, Laval (CA)

(73) Assignee: InterDigital Patent Holdings, Inc., Wilmington, DE (US)

(21) Appl. No.: 18/901,655

(22) Filed: Sep. 30, 2024

(51) Int. Cl. H04W 24/10; H04L 5/00; H04W 36/00

(52) U.S. Cl. CPC H04W 24/10; H04L 5/0048; H04W 36/0016

(57) ABSTRACT

Systems, methods, and instrumentalities are described herein for performing channel state information acquisition of candidate cells. A device (e.g., a WTRU) may include a processor configured to perform one or more actions. The device may receive configuration information. The configuration information may be associated with a layer 1/2 triggered mobility (LTM) channel state information (CSI) resource set. Based on the configuration information, the device may perform a measurement on an LTM CSI resource from the LTM CSI resource set. The device may determine to include the LTM CSI resource in a selected resource set. The determination to include the LTM CSI resource in the selected resource set may be based on a condition being satisfied. The condition may be associated with the measurement on the LTM CSI resource. The device may transmit an LTM report.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, and instrumentalities are described herein for performing channel state information acquisition of candidate cells. A device (e.g., a wireless transmit/receive unit (WTRU)) may include a processor configured to perform one or more actions. The device may receive configuration information. The configuration information may be associated with a layer 1/2 triggered mobility (LTM) channel state information (CSI) resource set. Based on the configuration information, the device may perform a measurement on an LTM CSI resource from the LTM CSI resource set. The device may determine to include the LTM CSI resource in a selected resource set. The determination to include the LTM CSI resource in the selected resource set may be based on a condition being satisfied. The condition may be associated with the measurement on the LTM CSI resource. The device may transmit an LTM report. The LTM report may include a first indication of the measurement on the LTM CSI resource and a second indication of whether the condition is satisfied to include the LTM CSI resource in the selected resource set. The device may measure a CSI associated with the selected resource set. The device may transmit the measured CSI that is associated with the selected resource set.

In examples, the LTM CSI resource set may include at least one of a set of non-zero power (NZP) CSI-reference signal (RS) resources for a channel measurement, a set of NZP CSI-RS resources for an interference measurement, and/or a set of CSI-interference measurement (IM) resources for an interference measurement. In examples, the LTM CSI resource set may include at least one of a set of resources for a channel measurement or a set of resources for a channel interference measurement. The channel measurement or the channel interference measurement may be associated with a CSI measurement of an LTM candidate cell or an LTM target cell.

In examples, the configuration information may further include reporting configuration information. The reporting configuration information may be associated with LTM CSI report configuration information. The LTM CSI report configuration information may indicate at least one of whether a reporting associated with an LTM candidate cell is periodic, aperiodic, semi-persistent on a Physical Uplink Control Channel (PUCCH) or a Physical Uplink Shared Channel (PUSCH), reporting quantity information, reporting frequency information, codebook configuration information, or reporting resource information. In examples, the selected resource set may include at least one of the LTM CSI resource set for a channel measurement or the LTM CSI resource set for an interference measurement.

In examples, the configuration information may be first configuration information. The device may receive second configuration information. The second configuration information may associate an LTM measurement resource with an LTM CSI resource set. The LTM measurement resource may include at least one of a synchronization signal block (SSB) CSI-RS of an LTM candidate cell or a NZP CSI-RS of an LTM candidate cell. In examples, the determination of the selected resource set from the LTM CSI resource set may include the device receiving a message from a base station. The message may indicate an LTM CSI resource set to be included in the selected resource set. The message may be received via a radio resource control (RRC) message or a medium access control (MAC) control element (CE) message.

In examples, the device may receive a physical downlink control channel (PDCCH) triggering measurement message. The PDCCH triggering measurement message may indicate a resource, from the selected resource set, to perform a CSI measurement based on the LTM report. In examples, the condition may include a determination that the measurement on the LTM CSI resource is above a first threshold, a determination that the measurement on the LTM CSI resource is higher than a measurement of a serving beam, or a determination that the measurement of the serving beam is lower than a second threshold and the measurement on the LTM CSI resource is above a third threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating a WTRU configured to report channel state information (CSI) for at least one selected layer 1/2 -triggered mobility (LTM) CSI resource set.

### DETAILED DESCRIPTION

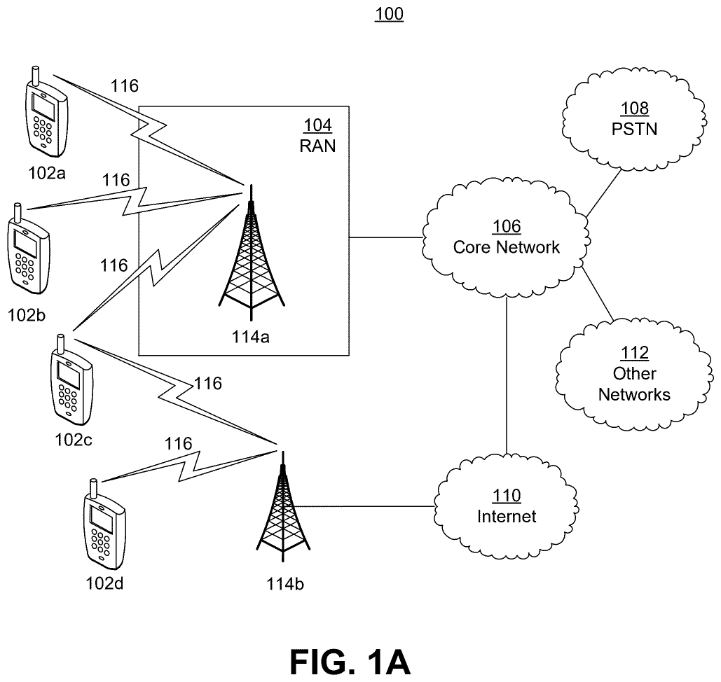

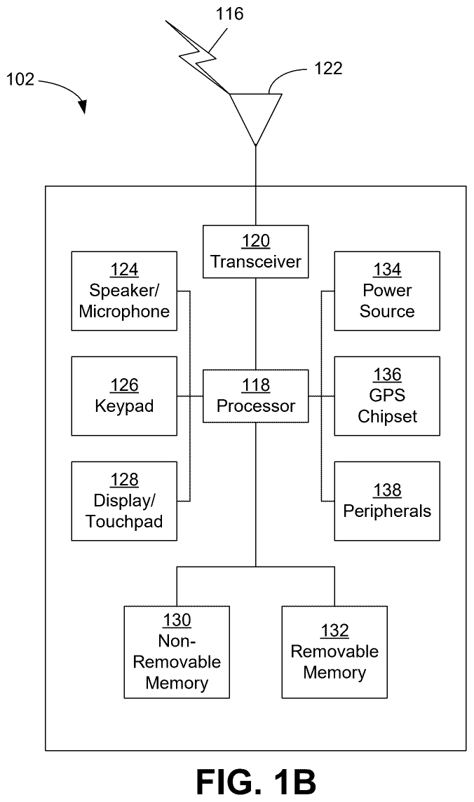

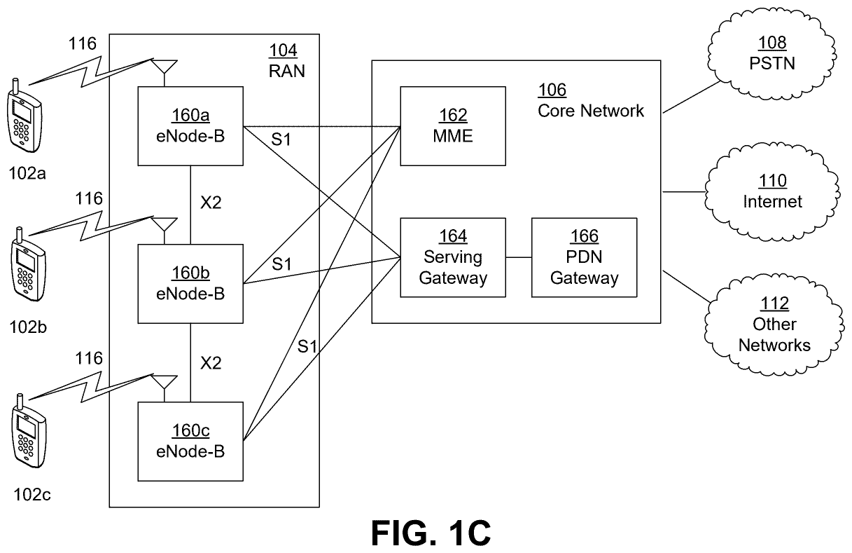

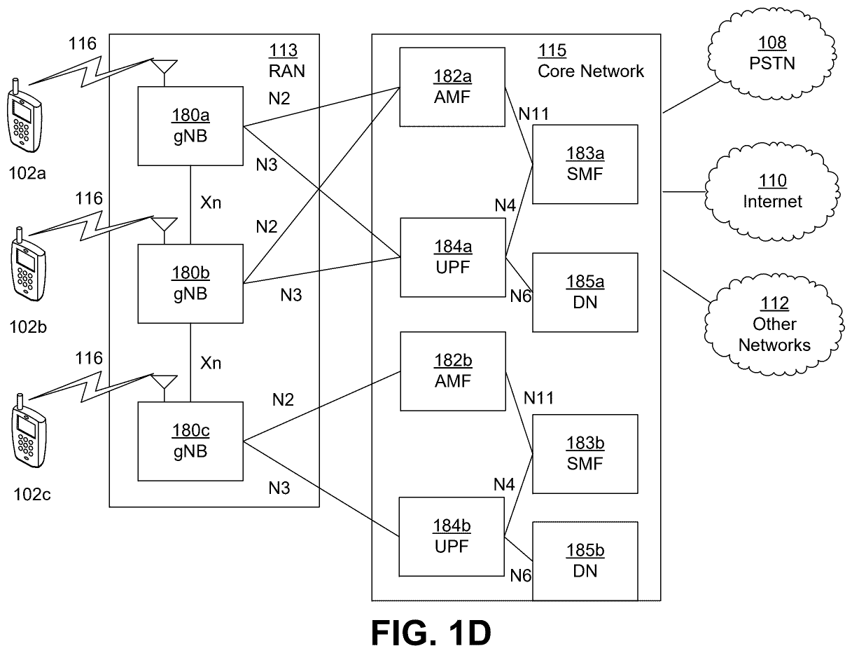

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and instrumentalities are described herein for performing channel state information acquisition of candidate cells. A device (e.g., a WTRU) may include a processor configured to perform one or more actions. The device may receive configuration information. The configuration information may be associated with a layer 1/2 triggered mobility (LTM) channel state information (CSI) resource set. Based on the configuration information, the device may perform a measurement on an LTM CSI resource from the LTM CSI resource set. The device may determine to include the LTM CSI resource in a selected resource set. The determination to include the LTM CSI resource in the selected resource set may be based on a condition being satisfied. The condition may be associated with the measurement on the LTM CSI resource. The device may transmit an LTM report. The LTM report may include a first indication of the measurement on the LTM CSI resource and a second indication of whether the condition is satisfied to include the LTM CSI resource in the selected resource set. The device may measure a CSI associated with the selected resource set. The device may transmit the measured CSI that is associated with the selected resource set.

In examples, the LTM CSI resource set may include at least one of a set of non-zero power (NZP) CSI-reference signal (RS) resources for a channel measurement, a set of NZP CSI-RS resources for an interference measurement, or a set of CSI-interference measurement (IM) resources for an interference measurement. In examples, the LTM CSI resource set may include at least one of a set of resources for a channel measurement or a set of resources for a channel interference measurement. The channel measurement or the channel interference measurement may be associated with a CSI measurement of an LTM candidate cell or an LTM target cell.

In examples, the configuration information may further include reporting configuration information. The reporting configuration information may be associated with LTM CSI report configuration information. The LTM CSI report configuration information may indicate at least one of whether a reporting associated with an LTM candidate cell is periodic, aperiodic, semi-persistent on a Physical Uplink Control Channel (PUCCH) or a Physical Uplink Shared Channel (PUSCH), reporting quantity information, reporting frequency information, codebook configuration information, or reporting resource information. In examples, the selected resource set may include at least one of the LTM CSI resource set for a channel measurement or the LTM CSI resource set for an interference measurement.

In examples, the configuration information may be first configuration information. The device may receive second configuration information. The second configuration information may associate an LTM measurement resource with an LTM CSI resource set. The LTM measurement resource may include at least one of a synchronization signal block (SSB) CSI-RS of an LTM candidate cell or a NZP CSI-RS of an LTM candidate cell. In examples, the determination of the selected resource set from the LTM CSI resource set may include the device receiving a message from a base station. The message may indicate an LTM CSI resource set to be included in the selected resource set. The message may be received via a radio resource control (RRC) message or a medium access control (MAC) control element (CE) message.

In examples, the device may receive a physical downlink control channel (PDCCH) triggering measurement message. The PDCCH triggering measurement message may indicate a resource, from the selected resource set, to perform a CSI measurement based on the LTM report. In examples, the condition may include a determination that the measurement on the LTM CSI resource is above a first threshold, a determination that the measurement on the LTM CSI resource is higher than a measurement of a serving beam, or a determination that the measurement of the serving beam is lower than a second threshold and the measurement on the LTM CSI resource is above a third threshold. The LTM report may include a first indication of the measurement on the LTM CSI resource and a second indication of whether the condition is satisfied to include the LTM CSI resource in the selected resource set. The device may measure a CSI associated with the selected resource set. The device may transmit the measured CSI that is associated with the selected resource set.

Standardized layer 1/2-triggered mobility (LTM) may be provided. In LTM, a WTRU may perform measurements such as Layer 1 Reference Signal Received Power (L1-RSRP) on reference signals corresponding to beams of candidate cells. The reference signal may be a synchronization signal block (SSB). The WTRU may report the measurement results using L1 reporting mechanism (e.g., on PUCCH). The network may make a decision to handover (e.g., cell switch) to a target cell based on the L1 report(s). The network may provide the command using a MAC control element.

Enhancements to mobility procedures may be provided. An enhancement may enable the WTRU to acquire channel state information (CSI) on candidate cell(s) based on CSI reference signal (CSI-RS) before or during Layer 1/2-triggered mobility (LTM) cell switch. This may enable the WTRU to timely provide CSI information relevant to the target cell and/or get downlink data with high throughput (e.g., immediately) after the cell switch. The CSI may include, for example, at least one of a CSI-RS resource indicator (CRI), rank indicator (RI), layer indicator (LI), pre-coding matrix indicator (PMI), and channel quality indicator (CQI).

CSI measurements may require configuration of multiple measurement resources (e.g., CSI resource sets). The CSI resource sets may include channel measurement resources such as non-zero-power (NZP) CSI-RS resource set(s) and/or interference measurement resource(s) such as CSI interference measurement (CSI-IM) resources or NZP CSI-RS resources. The WTRU may report the CSI measurement results using aperiodic, semi-persistent, or periodic reports. In aperiodic and semi-persistent reporting, the WTRU may determine the CSI resource sets based on a trigger state indicated in the command triggering the CSI report. More specifically, RRC may configure a set of CSI resource sets for each configured trigger state. The WTRU may measure over such CSI resource sets after receiving the indication of the trigger state. If receiving the command by downlink control information (DCI), the WTRU may indicate one out of a (e.g., maximum) number of trigger states determined by the size of a CSI request field. The maximum size of this field may be 6 bits, allowing indication from a set of 64 trigger states.

To perform CSI measurements of candidate cells in LTM operation, a WTRU first may (e.g., need to) receive configuration (e.g., by RRC) of all resource sets across the candidate cells that may (e.g., potentially) be required for these measurements. In examples, the (e.g., maximum) number of candidate cells may be 8. The number of such resource sets may become (e.g., significantly) (e.g., 8 times) higher than if the WTRU (e.g., only needs to perform) performs CSI measurements within its serving cell.

To keep CSI measurement and/or reporting overhead to a manageable level, the WTRU may (e.g., need to) report CSI (e.g., only) for a (e.g., reasonably small) subset of the CSI resource sets configured for the candidate cells. The subset may correspond to the (e.g., strongest) measured beams. If aperiodic triggering or semi-persistent triggering is used, the network may achieve this by configuring one trigger state for each potential combination of CSI resource sets. The network may indicate the appropriate trigger state depending on the strongest beams reported by the WTRU. The indication may not scale if more than a few LTM candidate cells are configured as the number of possible combinations becomes (e.g., very) large. The WTRU may measure and/or report CSI for an appropriate subset of CSI resource sets of the LTM candidate cells.

A WTRU may be enabled to acquire and/or report CSI of candidate cells if configured for L1/2-triggered mobility (LTM). The WTRU may receive a CSI resource and/or reporting configuration(s) for a (e.g., each) candidate cell(s) of the LTM configuration (e.g., may receive a respective CSI resource and/or reporting configuration for each respective candidate cell(s) of the LTM configuration). The WTRU may determine (e.g., further determine) an association between an LTM measurement resource and a set of CSI resource sets and/or one or more CSI reporting configurations, for at least one LTM measurement resource. The WTRU may determine an applicable set(s) of CSI resource sets and/or CSI reporting configurations (e.g., selected set) based on a (e.g., an explicit) signaling and/or based on whether a condition is satisfied for the associated LTM measurement resource. The WTRU may measure and/or report CSI for the applicable set(s) and/or configuration (e.g., possibly) if there is a reception of aperiodic-CSI (A-CSI) or semi persistent-CSI (SP-CSI) trigger with an indicated trigger state configured with the selected set.

The WTRU may receive one or more configurations (e.g., configuration information). For example, the WTRU may receive configuration information. As described herein, the configuration (e.g., the configuration information) may be associated with an LTM CSI resource set. In examples, the LTM CSI resource set may be, or may include, at least one of a set of non-zero power (NZP) CSI-reference signal (RS) resources for a channel measurement, a set of NZP CSI-RS resources for an interference measurement, or a set of CSI-interference measurement (IM) resources for an interference measurement. In examples, the LTM CSI resource set may be, or may include, at least one of a set of resources for a channel measurement or a set of resources for a channel interference measurement. The channel measurement and/or the channel interference measurement may be associated with a CSI measurement of an LTM candidate cell and/or an LTM target cell.

In examples, a configuration (e.g., configuration information) may include (e.g., indicate), for at least one LTM candidate cell, a set of LTM measurement resources, one or more LTM measurement configurations, one or more sets of LTM CSI resource sets, and/or a set of LTM CSI reporting configurations. In examples, a configuration (e.g., configuration information) may include (e.g., indicate) an association between an LTM measurement resource and a set of LTM CSI resource sets and an LTM CSI reporting configuration (e.g., associated CSI), e.g., for at least one LTM measurement resource. In examples, a configuration (e.g., configuration information) may include (e.g., indicate) at least a condition to be satisfied for an LTM measurement resource for including its associated CSI in a selected set. In examples, a configuration (e.g., configuration information) may include (e.g., indicate) at least one aperiodic or semi-persistent trigger state and/or an indication that a selected set of CSI is to be reported. In examples, a configuration (e.g., configuration information) may include reporting configuration information. For example, the reporting configuration information may be associated with LTM CSI report configuration information. The LTM CSI report configuration information may indicate at least one of whether a reporting associated with an LTM candidate cell is periodic, aperiodic, semi-persistent on a Physical Uplink Control Channel (PUCCH) or a Physical Uplink Shared Channel (PUSCH), reporting quantity information, reporting frequency information, codebook configuration information, or reporting resource information. In examples, a configuration (e.g., configuration information) may associate an LTM measurement resource with an LTM CSI resource set. The LTM measurement resource may be, or may include, at least one of a synchronization signal block (SSB) CSI-RS of an LTM candidate cell or a NZP CSI-RS of an LTM candidate cell.

The WTRU may perform one or more measurements on at least one LTM measurement resource based on LTM measurement configuration. For example, the WTRU may perform a measurement (e.g., channel measurement and/or interference measurement) on an LTM CSI resource from the LTM CSI resource set.

The WTRU may determine that an LTM measurement report is to be transmitted (e.g., determine to transmit an LTM measurement report). In examples, the WTRU may determine to transmit the LTM measurement report based on a measurement condition being satisfied for at least one LTM measurement resource according to an event-based LTM reporting configuration. The WTRU may determine, for each LTM measurement resource included in the LTM measurement report, if a condition is satisfied for a reporting associated CSI.

In examples, the WTRU may determine to include the LTM CSI resource in a selected resource set. The selected resource set may be, or may include, at least one of the LTM CSI resource set for a channel measurement and/or at least one LTM CSI resource set for an interference measurement. As described herein, the determination to include the LTM CSI resource in the selected resource set may be based on a condition being satisfied. The condition may be associated with the measurement on the LTM CSI resource. In examples, as described herein, the condition may be one or more of the following: determine whether the associated LTM measurement resource is included in the LTM report; determine whether the associated LTM measurement resource causes triggering of an LTM event and possibly under a condition that LTM event configuration indicates that the LTM measurement resource should be included; determine whether the associated LTM measurement resource does not cause triggering of an LTM event due to “report on leave” being configured; determine whether the measurement result of the associated LTM measurement resource is higher than a first threshold; determine whether the measurement result of the associated LTM measurement resource is offset higher than measurement result of serving beam; determine whether the measurement result of the serving cell becomes worse than second threshold and measurement result of associated LTM measurement resource becomes better than a third threshold; and/or determine whether the measurement result of the associated LTM measurement resource is one of N strongest measurement results included in the report, e.g., possibly for a given frequency

The WTRU may transmit an LTM report. In examples, the LTM report may be, or may include, an indication of the measurement of the LTM CSI resource. The LTM report may be, or may include, another indication (e.g., a second indication) indicating whether the condition is satisfied to include the LTM CSI resource in the selected resource set. In examples, the LTM report may include (e.g., indicate) one or more measurement results of at least one LTM measurement resource and/or an indication of whether a condition is satisfied for including its associated CSI in a selected set.

The WTRU may receive a PDCCH (e.g., DCI) triggering measurement and/or reporting of A-CSI for a trigger state configured for reporting of the selected set. For example, the PDCCH triggering measurement message may indicate a resource, e.g., from the selected resource set, to perform a CSI measurement based on the LTM report.

The WTRU may measure CSI of the selected set. The WTRU may report one or more results (e.g., one or more measurement results) in the resource indicated by the PDCCH.

A CSI acquisition of candidate cell(s) may be enabled in an LTM operation, e.g., for the purpose of maximizing throughput performance as early as possible after a cell switch. The WTRU may be enabled to measure and/or provide CSI information on the most relevant resources (e.g., resources that are most likely to correspond to resources used for scheduling the WTRU after cell switch). Pre-configuration of a large number of trigger states for any potential combination of CSI's among resources of LTM candidate cells may be skipped (e.g., not be required).

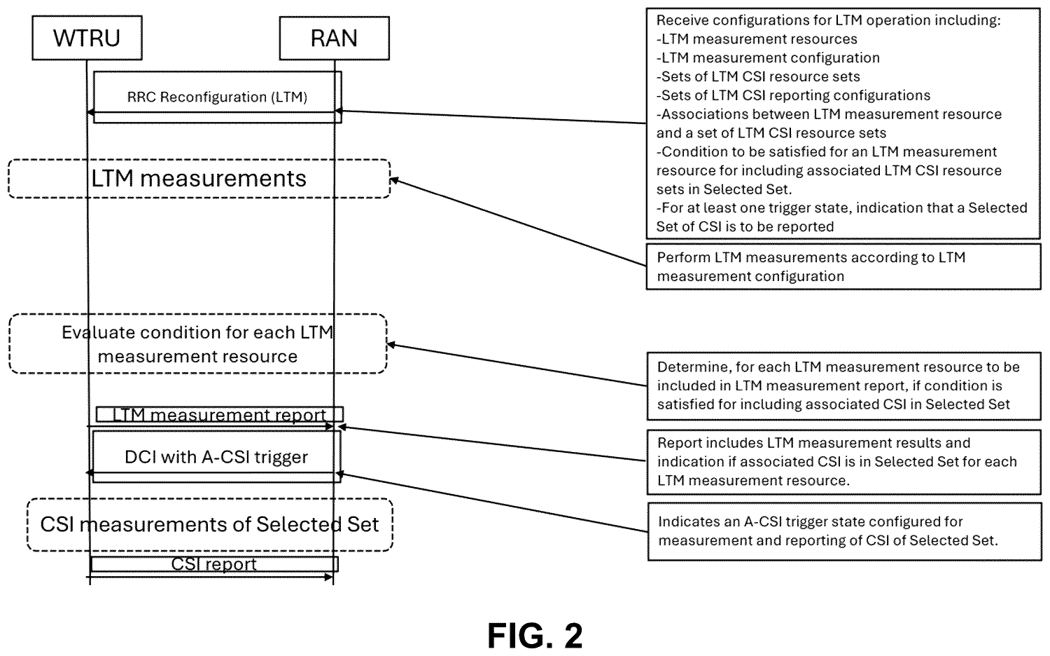

FIG. 2 depicts a WTRU configured to report channel state information (CSI) for at least one selected layer 1/2 triggered mobility (LTM) CSI resource set.

The selected set of LTM CSI resource sets may be determined. The WTRU may be configured to report CSI for at least one selected set of the LTM CSI resource set from a set of LTM CSI resource sets and/or at least one LTM CSI resource configuration. The at least one selected set may be updated (e.g., dynamically) for at least one aperiodic and/or semi-persistent trigger state and/or report configuration.

One or more configurations (e.g., configuration information) for CSI measurement and reporting of one or more LTM candidate cells and/or LTM target cells may be received and/or determined. A WTRU may receive one or more configurations for performing one or more LTM operations for a set of LTM candidate cells. Such LTM operations may include at least one of LTM measurements (e.g., reporting of L1-RSRP), transmission of PRACH for the purpose of UL synchronization for an LTM candidate cell, cell switch to a target cell within the LTM candidate cells, and the like. The WTRU may receive one or more configurations for CSI measurement and/or reporting of an LTM candidate cell(s) and/or an LTM target cell(s), as described herein.

CSI resource and/or report configuration for LTM candidate cell may be provided. The WTRU may receive one or more configurations for resources for CSI measurement and/or reporting of at least one LTM candidate cell or target cell. The configurations may include a set of NZP CSI-RS resources and NZP CSI-RS resource sets for channel measurements and/or interference measurements. The configurations may include a set of CSI-IM resources and/or CSI-IM resource sets for interference measurements. A set of resources for channel and/or interference measurements for CSI measurement of an LTM candidate cell or LTM target cell may be referred to as an LTM CSI resource set herein.

The WTRU may receive at least one configuration (e.g., at least one reporting configuration) for CSI reporting aspects for at least one LTM candidate cell. For example, the reporting configuration (e.g., reporting configuration information) may be whether (e.g., indicate whether) the reporting is periodic, aperiodic, semi-persistent on PUCCH or PUSCH, reporting quantities, frequency configurations, codebook configurations, reporting resource(s), or the like. Such configuration may be referred to as LTM CSI report configuration herein.

The WTRU may receive one or more configurations for an (e.g., each) LTM candidate cell. In examples herein, the WTRU may receive the configuration(s) via configuration information that includes or indicates the configuration(s).

Resource and/or report configurations for LTM measurements may be provided. The WTRU may receive one or more configurations for a resource(s) for the purpose of LTM measurement and/or reporting of at least one LTM candidate cell. An LTM report may include (e.g., indicate), for example, L1-RSRP results for at least one SSB or CSI-RS resource associated with LTM candidate cell(s).

The WTRU may receive at least one reporting configuration for LTM measurement and reporting. A reporting configuration may include a resource(s) for LTM measurements and/or indicate aspects such as whether reporting is periodic, aperiodic, semi-persistent, or event-based. If event-based reporting is configured, the reporting configuration may be associated to an event configuration defining the type of event (e.g., candidate beam becomes offset better than serving beam, serving beam becomes higher/lower than threshold, etc.) and associated parameters.

Association between LTM measurement resource and LTM CSI resource set may be provided. The WTRU may receive a configuration (e.g., configuration information) associating an LTM measurement resource to a set of LTM CSI resource sets and possibly an LTM CSI report configuration, for at least one LTM measurement resource. Such set of LTM CSI resource sets and LTM CSI report configuration may be referred to as the associated CSI of the LTM measurement resource.

In examples, the WTRU may receive a configuration (e.g., configuration information) for a set of LTM measurement resources. An (e.g., each) LTM measurement resource may include an SSB or NZP CSI-RS of an LTM candidate cell. The WTRU may receive, for each LTM measurement resource, the identities of at least one associated LTM CSI resource set. In examples, a set of LTM measurement resources may include SSB indices {3, 4, 5, 3, 4} of LTM candidate cells {1, 1, 1, 2, 2} respectively. The associated LTM CSI resource sets may include LTM NZP CSI-RS resource sets {8, 9, 10, 5, 6} for channel measurements and LTM CSI-IM resource sets {1, 1, 1, 2, 2} for interference measurements configured as part of LTM candidate cells {1, 1, 1, 2, 2} respectively.

The WTRU may receive at least one configuration for transmission configuration indication (TCI) related information for an LTM candidate cell. The WTRU may use this configuration during activation of TCI state(s) and/or upon reception of LTM cell switch command. A TCI related configuration may include a set of at least one candidate TCI state and at least one NZP CSI-RS resource, where a (e.g., each) candidate TCI state may be associated with one of the configured NZP CSI-RS resources or with an SSB resource of the candidate cell. The candidate TCI state may be a downlink, uplink, and/or joint uplink-downlink TCI state.

Association between candidate TCI state and LTM CSI resource set may be provided. The WTRU may receive a configuration (e.g., configuration information) associating a candidate TCI state to a set of LTM CSI resource sets and possibly an LTM CSI report configuration, for at least one candidate TCI state. Additionally and/or alternatively, the WTRU may receive configuration associating a SSB or NZP CSI-RS resource to a set of LTM CSI resource sets and LTM CSI report configuration, for at least one SSB or NZP CSI-RS resource configured as part of TCI related information for an LTM candidate cell. The set of LTM CSI resource sets and LTM CSI report configuration may be referred to as the associated CSI of the candidate TCI state or of the SSB or NZP CSI-RS resource.

The WTRU may receive configuration(s) by RRC signaling as part of LTM configuration and/or by MAC control element (CE). A WTRU may determine at least one selected set of LTM CSI resource sets for the purpose of CSI measurement and/or reporting of LTM candidate cell(s) or target cell. A selected set may include at least one LTM CSI resource set for channel measurements and/or (e.g., possibly) at least one LTM CSI resource set for interference measurements.

Determination based on explicit signaling may be provided. The WTRU may receive signaling from a base station (e.g., gNB) and/or a network (e.g., explicitly) indicating which LTM CSI resource set(s) are to be included or excluded from a selected set and the identity of the selected set. The signaling may include RRC signaling or MAC control element. For example, the WTRU may receive a message from a base station, such as a gNB. The message may indicate an LTM CSI resource set to be included in the selected resource set. The message may be received via an RRC message and/or a MAC CE message. Determination of a selected set of LTM CSI resource sets may be provided. The signaling may include identities of LTM CSI resource sets, LTM CSI report configuration, and/or the identities of associated LTM measurement resources. The WTRU may determine which LTM CSI resource set(s) and LTM CSI report configuration are associated to an indicated LTM measurement resource and may include or exclude such LTM CSI resource set(s) from the selected set accordingly.

A determination may be performed based on LTM measurement results. The WTRU may perform LTM measurements and/or determine whether an LTM CSI resource set is included or excluded in a selected set based on the LTM measurement results. The WTRU may trigger transmission of an LTM report based on the determination. The WTRU may (e.g., additionally and/or alternatively) make this determination if an LTM report is to be transmitted based on any condition.

Applicable LTM reports may be provided. The WTRU may update a selected set based on an LTM report if (e.g., only if) the LTM report is an applicable LTM report. The WTRU may determine whether an LTM report is applicable based on whether the LTM report is event-triggered or periodic. In examples, an LTM report may be applicable if (e.g., only if) it is event-triggered. The WTRU may determine whether an LTM report is applicable based on whether the LTM report is transmitted using MAC CE or L1 signaling. The WTRU may determine whether an LTM report is applicable based on the type of event (e.g., if the LTM report is event-triggered). In examples, a type of event may include LTM2 (e.g., beam of serving cell becomes worse than absolute threshold), LTM3 (e.g., beam of candidate cell becomes amount of offset better than beam of serving cell), LTM4 (e.g., beam of candidate cell becomes better than absolute threshold), and/or LTM5 (e.g., beam of serving cell becomes worse than absolute threshold1 and/or beam of candidate cell becomes better than another absolute threshold2). The WTRU may determine whether an LTM report is applicable based on an (e.g., explicit) indication within the LTM report configuration or event-triggered configuration. Such (e.g., explicit) indication may include the identity of at least one selected set that may be updated based on the contents of the LTM report.

One or more conditions for inclusion or exclusion in a selected set may be provided. The WTRU may include or exclude an LTM CSI resource set in a selected set if at least one condition is satisfied for the measurement result of its associated LTM measurement resource and/or other LTM measurement resource. The at least one condition may include or exclude an LTM CSI resource set if the associated LTM measurement resource is included in the LTM report. The at least one condition may include or exclude an LTM CSI resource set if the associated LTM measurement resource causes or does not cause triggering of an LTM event, and possibly under a condition that LTM event configuration indicates that it should be included. In examples, such a resource may correspond to the beam of a candidate that becomes better than the absolute threshold if the LTM4 event is configured. The at least one condition may exclude or include an LTM CSI resource set if the associated LTM measurement resource causes triggering of an LTM event due to “report on leave” being configured. The at least one condition may include or exclude an LTM CSI resource set if the measurement result of the associated LTM measurement resource is higher or lower than a first threshold. The at least one condition may include or exclude an LTM CSI resource set if the measurement result of the associated LTM measurement resource is offset higher (e.g., or lower) than the measurement result of serving beam. The at least one condition may include or exclude an LTM CSI resource set if measurement result of the serving cell becomes worse than second threshold and measurement result of associated LTM measurement resource becomes better than a third threshold. The at least one condition may include or exclude a measurement result of the associated LTM measurement resource being one or not being one (e.g., respectively) of the N strongest measurement results included in the report. The inclusion or exclusion may be performed for a given frequency.

One or more conditions for inclusion or exclusion in a selected set at cell level may be provided. A WTRU may include an LTM CSI resource set in a selected set if at least one condition (e.g., as described herein) is satisfied for one or more LTM measurement resource(s) of the same LTM candidate cell as the associated LTM measurement resource. A WTRU may exclude an LTM CSI resource set in a selected set if the at least one condition (e.g., as described herein) is satisfied or not satisfied for one or more (e.g., all) LTM measurement resources of the same LTM candidate cell as the associated LTM measurement resource.

A WTRU may include or exclude an LTM CSI resource set in a selected set based on whether at least one condition is satisfied for a minimum number L of LTM measurement resources of the associated LTM candidate cell. In examples, a condition for inclusion may be that for at least L LTM measurement resources, the measurement result is above a first threshold. Another condition may be that for at least one LTM measurement resource, the measurement result is above a second threshold.

Configurability aspects may be provided. The selected set, conditions, and/or associated parameters (e.g., the values of absolute, first, second, and third threshold, the value of N, the value of offset, applicable frequencies, and/or the like) may be configured by RRC and/or MAC signaling. At least one parameter may be separately configurable for an (e.g., each) LTM candidate cell to which the LTM CSI resource set or its associated LTM measurement resource is associated. Configurability by the LTM candidate cell may have the benefit of allowing the network to obtain a desired amount of CSI information depending on the frequency and/or distributed unit controlling the resources of the LTM candidate cell.

One or more subsequent LTM reports may be transmitted. The WTRU may determine a selected set based on the latest M transmitted LTM report only. M may be configured by RRC and/or MAC signaling and/or predefined. If M is larger than one, the WTRU may retain an LTM CSI resource set in a selected set if the latest measurement result for the associated LTM measurement result across the latest M transmitted LTM reports satisfies the inclusion condition. The WTRU may (e.g., otherwise) include or exclude the LTM CSI resource set.

A selected set may have a maximum size. A maximum number K of LTM CSI resource sets may be configured for a selected set. The value of K may be pre-defined or signaled by RRC or MAC. If more than the maximum number of LTM CSI resource sets satisfy one or more inclusion conditions, the WTRU may prioritize K best LTM CSI resource sets according to at least one priority condition. The at least one priority condition may include a measurement result of associated LTM measurement resource. In examples, LTM CSI resource sets associated to LTM measurement resources with the strongest L1-RSRP may be prioritized. The at least one priority condition may include frequency of LTM CSI resource set or of associated LTM measurement resource(s). In examples, resource in the same frequency as serving cell may be prioritized. The at least one priority condition may include explicit priority indication (e.g., level) configured for the LTM CSI resource set or for its associated LTM measurement resource. The WTRU may apply more than one priority condition. The WTRU may apply each of the more than one conditions according to a specific order (e.g., explicit priority level first then measurement result second). The WTRU may retain LTM CSI resource sets that have been determined within a time period, such as the last T seconds. The value T may be pre-defined or signaled by RRC or MAC.

Determination based on early UL synchronization may be provided. The WTRU may be configured to perform early uplink synchronization to one of at least one candidate cell. The WTRU may receive a PDCCH triggering PRACH transmission for an indicated candidate cell. The WTRU may select an SSB index as part of this procedure for the purpose of determining a random access occasion and/or a preamble. The WTRU may be configured with an association between an SSB index of a candidate cell and at least one LTM CSI resource set, e.g., for at least one SSB index of a candidate cell. The WTRU may receive explicit signaling for this association. The WTRU may (e.g., additionally and/or alternatively) reuse quasi-colocation (QCL) information configured for each NZP CSI-RS resource of an LTM CSI resource set to determine the association. The WTRU may include in a selected set at least one LTM CSI resource set associated to the SSB index selected for the transmission of PRACH.

The WTRU may (e.g., additionally and/or alternatively) include one or more (e.g., all) LTM CSI resource sets associated to the candidate cell indicated in the PDCCH triggering early uplink synchronization in a selected set. The WTRU may retain LTM CSI resource sets determined from last M early uplink synchronization procedures. The WTRU may retain such LTM CSI resource sets that have been determined within a time period, such as the last T seconds. The values of M and T may be configured by RRC and/or MAC signaling.

Determination based on a cell switch command may be provided. The WTRU may receive a cell switch command (e.g., in a MAC control element) indicating a target cell. The cell switch command may indicate the identity of a TCI state for the target cell. The WTRU may be configured with an association between a TCI state of an LTM candidate configuration (e.g., cell) and at least one LTM CSI resource set for at least one TCI state. The WTRU may (e.g., additionally and/or alternatively) determine an association between a TCI state and at least one LTM CSI resource set based on the reference signal configured for the TCI state and an association between this reference signal and the at least one LTM CSI resource set. The WTRU may include the at least one LTM CSI resource set associated with the TCI state indicated in the cell switch command in a selected set. The WTRU may exclude one or more (e.g., all) other LTM CSI resource sets from the selected set. Such selected set may be referred to as target cell selected set.

A determination based on Candidate Cell TCI States Activation/Deactivation MAC control element may be performed. The WTRU may receive a MAC control element activating or deactivating candidate cell TCI states. The WTRU may include in a Selected Set the at least one LTM CSI resource set associated to each activated candidate cell TCI state or associated to the SSB or NZP CSI-RS resource configured as reference signal for the activated candidate cell TCI state. The WTRU may exclude of a Selected Set the at least one LTM CSI resource set associated to each de-activated candidate cell TCI state or associated to the SSB or NZP CSI-RS resource configured as reference signal for the de-activated candidate cell TCI state.

An indication of a selected set may be provided. The WTRU may transmit an indication of the LTM CSI resource sets or of the associated LTM measurement resource that are included in a selected set (e.g., as described herein). In examples, the WTRU may include an additional field for an (e.g., each) LTM measurement resource included in an LTM report to indicate whether the associated LTM CSI resource set is to be associated in a selected set. The field may include a binary indication and/or of an indication of the identity of a selected set. In examples, the WTRU may transmit an indication whenever an update to a selected set is made. In examples, if a WTRU removes a CSI resource set (e.g., an LTE CSI resource) set from the selected set because a time period has elapsed since an associated CSI measurement resource (e.g., an associated LTE CSI measurement resource) met a condition for inclusion, the WTRU may transmit an indication of the selected set or corresponding change thereof. In examples, the WTRU may trigger transmission of an LTM report including the indication(s) if a CSI resource set (e.g., an LTE CSI resource set) is to be added or removed from a selected set based on at least one condition (e.g., condition(s) described herein).

Determination of LTM CSI report configuration for the selected set of LTM CSI resource sets may be performed.

A WTRU may determine at least one LTM CSI report configuration, e.g., an (e.g., each) LTM CSI report configuration may be applicable to a subset of LTM CSI resources sets included in the selected set. The WTRU may receive configuration associating an LTM CSI report configuration to an LTM measurement resource for at least one LTM measurement resource. The WTRU may (e.g., additionally and/or alternatively) receive configuration associating an LTM CSI report configuration to a set of LTM CSI resource sets. The WTRU may determine applicable LTM CSI report configuration for a set of LTM CSI resource sets included in a selected set (e.g., as described herein).

Triggering and reporting of CSI measurement for candidate cell may be provided. For a measurement initiation, the WTRU may initiate or stop CSI measurements and reporting according to LTM CSI resource sets and LTM CSI report configuration of a Selected Set if at least one of the following occurs.

The WTRU may initiate or stop CSI measurements and reporting according to LTM CSI resource sets and LTM CSI report configuration of a selected set after explicit signaling. The WTRU may initiate CSI measurements and reporting based on (e.g., after) reception of explicit signaling from the network indicating the set of LTM CSI resource sets and LTM CSI report configurations to be included in the selected set. The WTRU may stop CSI measurements and reporting of LTM CSI resource sets not included in the selected set based on the (e.g., explicit) signaling.

The WTRU may initiate or stop CSI measurements and reporting according to LTM CSI resource sets and LTM CSI report configuration of a selected set following reception of a cell switch command or an initial transmission to target cell. The WTRU may initiate CSI measurements and reporting after reception of cell switch command according to a selected set determined from this command. The WTRU may stop CSI measurements and reporting related to LTM CSI resource sets not included in a selected set, e.g., after reception of the cell switch command. The WTRU may stop CSI measurements related to LTM CSI resource sets not associated to the target cell indicated in the cell switch command. The WTRU may (e.g., additionally and/or alternatively) perform such actions after initial transmission to the target cell.

The WTRU may initiate or stop CSI measurements and reporting according to LTM CSI resource sets and LTM CSI report configuration of a selected set following transmission of LTM report or indication of a selected set. The WTRU may initiate CSI measurements and reporting for LTM CSI resource sets after transmission of LTM report that results in the inclusion of such LTM CSI resource sets. The WTRU may stop CSI measurements and reporting for LTM CSI resource sets after transmission of LTM report that results in the exclusion of such LTM CSI resource sets. The WTRU may (e.g., additionally and/or alternatively) initiate CSI measurements and reporting for LTM CSI resource sets for a selected set after transmission of indication of the set of LTM CSI resource sets included from a selected set. The WTRU may stop CSI measurements and reporting for LTM CSI resource sets for a selected set after transmission of an indication of the set of LTM CSI resource sets excluded from a selected set.

The WTRU may initiate or stop CSI measurements and reporting according to LTM CSI resource sets and LTM CSI report configuration of a selected set following A-CSI or SP-CSI triggering indicating state corresponding to reporting for a selected set. The WTRU may first receive configuration indicating, for at least one aperiodic trigger state or semi-persistent trigger state, that an applicable set of LTM CSI resource sets and LTM CSI report configuration for this trigger state includes LTM CSI resource sets and LTM CSI report configuration of a selected set. Such configuration, for example, may include the identity of a selected set for at least one selected set. The configuration of the aperiodic or semi-persistent trigger state may (e.g., additionally and/or alternatively) include at least one set of LTM CSI resource sets and LTM CSI report configurations. The WTRU may determine whether to perform measurement for a (e.g., each) set of LTM CSI resource sets and LTM CSI report configuration depending on whether such are included in a selected set based on at least one solution described in the above.

The WTRU may (e.g., then) receive PDCCH or MAC CE triggering the A-CSI or SP-CSI reporting for a trigger state indicating CSI measurement using LTM CSI resource sets and LTM CSI report configurations of a selected set. The WTRU may initiate such CSI measurements if reception occurs of the PDCCH or MAC CE.

A CSI report may be transmitted containing CSI measurement results of selected set. In the following, the term “periodic resource” may refer to at least one of a PUCCH or PUSCH resource with a configuration indicating period and offset (e.g., in terms of slots or symbols). The WTRU may obtain a PUCCH resource from a PUCCH configuration. The WTRU may obtain a PUSCH resource from a configured grant configuration, for example.

A resource may be indicated by A-CSI or SP-CSI trigger. The WTRU may transmit the CSI measurement results in a resource indicated by the PDCCH or MAC CE triggering A-CSI or SP-CSI reporting for a trigger state that is configured for reporting of a selected set.

A resource may be indicated by LTE CSI reporting configuration associated to LTM CSI resource sets. The WTRU may transmit the LTE CSI measurement results for a set of LTM CSI resource sets in a resource (e.g., a periodic resource) configured as part of an associated LTE CSI report configuration included in a selected set. A periodic resource (PUCCH or PUSCH) may (e.g., additionally and/or alternatively) be configured for a set of LTM CSI resource sets or an associated LTM measurement resource. The WTRU may report CSI for a set of LTM CSI resources in the periodic resource.

Resources configured for CSI reporting of LTM candidate cells may be provided. The WTRU may receive configuration associating a selected set to a set of reporting resources (e.g., such as PUCCH or PUSCH) for at least one selected set. Such set of reporting resources may include a set of periodic resources, for example. The WTRU may determine a maximum CSI payload for each resource in one time occasion. The WTRU may further determine a CSI payload (e.g., a required CSI payload) for a (e.g., each) CSI included in the Selected Set according to the corresponding LTM CSI report configuration. The WTRU may transmit, in each time occasion, a set of CSIs of the selected set for which the total required CSI payload does not exceed the maximum CSI payload of the resource. If the total required CSI payload of all set of CSIs of the selected set exceeds the (e.g., maximum) CSI payload of the resource, the WTRU may transmit a different subset of CSIs in an (e.g., each) occasion according to a cyclical sequence.

Resources in a target cell may be provided. The WTRU may provide CSI measurement results in a resource (e.g., PUCCH or PUSCH) after cell switch. Such resource may include a msgA transmission, msg3 transmission, or msg5 transmission or a subsequent transmission. The WTRU may determine the resource (e.g., PUCCH or PUSCH) for the provision of CSI measurement results in the target cell from RRC or MAC signaling. In examples, the LTM candidate cell configuration may include an indication of such resource and the WTRU may use this resource to report the CSI if the target cell is identified as this LTM candidate cell. The WTRU may (e.g., additionally and/or alternatively) provide CSI measurement results upon request from the network after execution of the cell switch. In examples, the WTRU may receive PDCCH or MAC CE triggering A-CSI or SP-CSI reporting for a trigger state configured for the transmission of CSI of target cell (or LTM candidate cell) or for a selected set. Such trigger state(s) and/or associated A-CSI codepoint may be signaled as part of the configuration of an LTM candidate cell.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to:
receive configuration information, wherein the configuration information is associated with a layer 1/2 triggered mobility (LTM) channel state information (CSI) resource set;
based on the configuration information, perform a measurement on an LTM CSI resource from the LTM CSI resource set;
determine to include the LTM CSI resource in a selected resource set, wherein the determination to include the LTM CSI resource in the selected resource set is based on a condition being satisfied, and wherein the condition is associated with the measurement on the LTM CSI resource;
transmit an LTM report, wherein the LTM report comprises a first indication of the measurement on the LTM CSI resource and a second indication of whether the condition is satisfied to include the LTM CSI resource in the selected resource set;
measure a CSI associated with the selected resource set; and
transmit the measured CSI that is associated with the selected resource set.

2. The WTRU of claim 1, wherein the LTM CSI resource set comprises at least one of a set of non-zero power (NZP) CSI-reference signal (RS) resources for a channel measurement, a set of NZP CSI-RS resources for an interference measurement, or a set of CSI-interference measurement (IM) resources for an interference measurement.

3. The WTRU of claim 1, wherein the LTM CSI resource set comprises at least one of a set of resources for a channel measurement or a set of resources for a channel interference measurement, wherein the channel measurement or the channel interference measurement is associated with a CSI measurement of an LTM candidate cell or an LTM target cell.

4. The WTRU of claim 1, wherein the configuration information further comprises reporting configuration information, wherein the reporting configuration information is associated with LTM CSI report configuration information, wherein the LTM CSI report configuration information indicates at least one of whether a reporting associated with an LTM candidate cell is periodic, aperiodic, semi-persistent on a Physical Uplink Control Channel (PUCCH) or a Physical Uplink Shared Channel (PUSCH), reporting quantity information, reporting frequency information, codebook configuration information, or reporting resource information.

5. The WTRU of claim 1, wherein the selected resource set comprises at least one of the LTM CSI resource set for a channel measurement or the LTM CSI resource set for an interference measurement.

6. The WTRU of claim 1, wherein the configuration information is first configuration information, and wherein the processor is configured to:
receive second configuration information, wherein the second configuration information associates an LTM measurement resource with an LTM CSI resource set, wherein the LTM measurement resource comprises at least one of a synchronization signal block (SSB) CSI-RS of an LTM candidate cell or a NZP CSI-RS of an LTM candidate cell.

7. The WTRU of claim 1, wherein to determine the selected resource set from the LTM CSI resource set comprises the processor being configured to:
receive a message from a base station, wherein the message indicates an LTM CSI resource set to be included in the selected resource set, wherein the message is received via a radio resource control (RRC) message or a medium access control (MAC) control element (CE) message.

8. The WTRU of claim 1, wherein the processor is configured to:
receive a physical downlink control channel (PDCCH) triggering measurement message, wherein the PDCCH triggering measurement message indicates a resource, from the selected resource set, to perform a CSI measurement based on the LTM report.

9. The WTRU of claim 1, wherein the condition comprises a determination that the measurement on the LTM CSI resource is above a first threshold, a determination that the measurement on the LTM CSI resource is higher than a measurement of a serving beam, or a determination that the measurement of the serving beam is lower than a second threshold and the measurement on the LTM CSI resource is above a third threshold.

10. A method comprising:
receiving configuration information, wherein the configuration information is associated with a layer 1/2 triggered mobility (LTM) channel state information (CSI) resource set;
based on the configuration information, performing a measurement on an LTM CSI resource from the LTM CSI resource set;
determining to include the LTM CSI resource in a selected resource set, wherein the determination to include the LTM CSI resource in the selected resource set is based on a condition being satisfied, and wherein the condition is associated with the measurement on the LTM CSI resource;
transmitting an LTM report, wherein the LTM report comprises a first indication of the measurement on the LTM CSI resource and a second indication of whether the condition is satisfied to include the LTM CSI resource in the selected resource set;
measuring a CSI associated with the selected resource set; and
transmitting the measured CSI that is associated with the selected resource set.

11. The method of claim 10, wherein the LTM CSI resource set comprises at least one of a set of non-zero power (NZP) CSI-reference signal (RS) resources for a channel measurement, a set of NZP CSI-RS resources for an interference measurement, or a set of CSI-interference measurement (IM) resources for an interference measurement.

12. The method of claim 10, wherein the LTM CSI resource set comprises at least one of a set of resources for a channel measurement or a set of resources for a channel interference measurement, wherein the channel measurement or the channel interference measurement is associated with a CSI measurement of an LTM candidate cell or an LTM target cell.

13. The method of claim 10, wherein the configuration information further comprises reporting configuration information, wherein the reporting configuration information is associated with LTM CSI report configuration information, wherein the LTM CSI report configuration information indicates at least one of whether a reporting associated with an LTM candidate cell is periodic, aperiodic, semi-persistent on a Physical Uplink Control Channel (PUCCH) or a Physical Uplink Shared Channel (PUSCH), reporting quantity information, reporting frequency information, codebook configuration information, or reporting resource information.

14. The method of claim 10, wherein the selected resource set comprises at least one of the LTM CSI resource set for a channel measurement or the LTM CSI resource set for an interference measurement.

15. The method of claim 10, wherein the configuration information is first configuration information, and wherein the method comprises:
receiving second configuration information, wherein the second configuration information associates an LTM measurement resource with an LTM CSI resource set, wherein the LTM measurement resource comprises at least one of a synchronization signal block (SSB) CSI-RS of an LTM candidate cell or a NZP CSI-RS of an LTM candidate cell.

16. The method of claim 10, wherein to determine the selected resource set from the LTM CSI resource set comprises:
receiving a message from a base station, wherein the message indicates an LTM CSI resource set to be included in the selected resource set, wherein the message is received via a radio resource control (RRC) message or a medium access control (MAC) control element (CE) message.

17. The method of claim 10, wherein the method comprises:
receiving a physical downlink control channel (PDCCH) triggering measurement message, wherein the PDCCH triggering measurement message indicates a resource, from the selected resource set, to perform a CSI measurement based on the LTM report.

18. The method of claim 10, wherein the condition comprises a determination that the measurement on the LTM CSI resource is above a first threshold, a determination that the measurement on the LTM CSI resource is higher than a measurement of a serving beam, or a determination that the measurement of the serving beam is lower than a second threshold and the measurement on the LTM CSI resource is above a third threshold.
